(19) United States
(12) Patent Application Publication
(10) Pub. No.: US 2019/0337851 A1
(43) Pub. Date: Nov. 7, 2019

(54) PREPARATION OF INURED ASPHALT BLOWN COATING

(71) Applicant: Denis Muki Tibah, Waxahachie, TX (US)

(72) Inventor: Denis Muki Tibah, Waxahachie, TX (US)

(73) Assignee: Building Materials Investment Corporation, Wilmington, DE (US)

(21) Appl. No.: 16/392,839

(22) Filed: Apr. 24, 2019

Related U.S. Application Data
(60) Provisional application No. 62/665,649, filed on May 2, 2018.

(51) Int. Cl. C04B 26/26; C04B 24/26; E04D 1/20; F16L 9/14; B32B 5/16; B32B 9/00

(52) U.S. Cl. CPC C04B 26/26; C04B 24/2611; E04D 1/20; C04B 2111/00525; B32B 5/16; B32B 9/005; F16L 9/14

(57) ABSTRACT

The present invention relates to a method for preparing a flexible and tough polymer modified asphalt composition which comprises sparging an oxygen containing gas through a liquid high-vinyl polybutadiene modified asphalt, wherein the liquid high-vinyl polybutadiene modified asphalt contains from about 0.25 weight percent to about 20 weight percent of the liquid high-vinyl polybutadiene, wherein the oxygen containing gas is sparged through the liquid high-vinyl polybutadiene modified asphalt at a temperature within the range of about 400° F. to about 550° F. for a period of time which is sufficient to increase the softening point of the asphalt to a value which is within the range of 185° F. to 250° F. and to attain a penetration value of at least 15 dmm to produce the polymer modified asphalt composition.

This application claims benefit of U.S. Provisional Patent Application Ser. No. 62/665,649, filed on May 2, 2018. The teachings of U.S. Provisional Patent Application Ser. No. 62/665,649 are incorporated herein by reference in their entirety.

### BACKGROUND OF THE INVENTION

The physical properties of asphalt have led to its widespread utilization in paving, roofing, waterproofing, and a wide variety of other industrial applications. For instance, asphalt is used in manufacturing roofing shingles because it has the ability to bind sand, aggregate, and fillers to the roofing shingle while simultaneously providing excellent water barrier characteristics.

Naturally occurring asphalts have been used in various applications for hundreds of years. However, today almost all of the asphalt used in industrial applications is recovered from the refining of petroleum. Asphalt and asphalt flux is essentially the residue that remains after gasoline, kerosene, diesel fuel, jet fuel, and other hydrocarbon fractions have been removed during the refining of crude oil. In other words, asphalt is the last cut from the crude oil refining process.

To meet performance standards and product specifications, asphalt that is recovered from refining operations is normally treated or processed to attain desired physical characteristics and to attain uniformity. For instance, asphalt that is employed in manufacturing roofing products has to be treated to meet the special requirements demanded in roofing applications. More specifically, in the roofing industry it is important to prevent asphaltic materials from flowing under conditions of high temperature such as those encountered during hot summers. In other words, the asphaltic materials used in roofing products should maintain a certain level of stiffness (hardness) at high temperatures. This increased level of stiffness is characterized by a reduced penetration, an increased viscosity, and an increased softening point.

To attain the required level of stiffness and increased softening point that is demanded in roofing applications the asphalt is typically treated by an air blowing process. In such air blowing techniques, air is blown through the asphalt for a period of about 1 hour to about 8 hours while it is maintained at an elevated temperature which is typically within the range of 400° F. (204° C.) to 550° F. (288° C.). The air blowing process optimally results in the stiffness and the softening point of the asphalt being significantly increased. This is highly desirable because ASTM D 3462-96 (Standard Specification for Asphalt Shingles Made from Glass Felt and Surfaced with Mineral Granules) requires roofing asphalt to have a softening point which is within the range of 190° F. (88° C.) to 235° F. (113° C.) and for the asphalt to exhibit a penetration at 77° F. (25° C.) of above 15 dmm (1 dmm=0.1 mm). In fact, it is typically desirable for asphalt used in roofing applications to have a penetration which is within the range of 15 dmm to 35 dmm in addition to a softening point which is within the range of 185° F. (85° C.) to 235° F. (113° C.).

Air blowing has been used to increase the softening point and stiffness of asphalt since the early part of the twentieth century. For example, U.S. Pat. No. 2,179,208 describes a process wherein asphalt is air blown at a temperature of 300° F. (149° C.) to 500° F. (260° C.) in the absence of a catalyst for a period of 1 to 30 hours after which time a catalyst is added for an additional treatment period of 20 to 300 minutes at a temperature of 225° F. (107° C.) to 450° F. (232° C.). Over the years a wide variety of chemical agents have been used as air blowing catalysts. For instance, ferric chloride, FeCl₃ (see U.S. Pat. No. 1,782,186), phosphorous pentoxide, P₂O₅ (see U.S. Pat. No. 2,450,756), aluminum chloride, AlCl₃ (see U.S. Pat. No. 2,200,914), boric acid (see U.S. Pat. No. 2,375,117), ferrous chloride, FeCl₂, phosphoric acid, H₃PO₄ (see U.S. Pat. No. 4,338,137), copper sulfate CuSO, zinc chloride ZnCl₂, phosphorous sesquesulfide, P₄S₃, phosphorous pentasulfide, P₂S₅, and phytic acid, C₆H₆O₆(H₂PO₃)₆ (see U.S. Pat. No. 4,584,023) have all been identified as being useful as air blowing catalysts.

U.S. Pat. No. 2,179,208 discloses a process for manufacturing asphalts which comprises the steps of air-blowing a petroleum residuum in the absence of any added catalysts while maintaining the temperature at about 149° C. to 260° C. (300° F. to 500° F.) and then heating the material at a temperature at least about 149° C. (300° F.) with a small amount of a polymerizing catalyst. Examples of such polymerizing catalysts include chlorosulphonic, phosphoric, fluoroboric, hydrochloric, nitric or sulfuric acids and halides as ferric chloride, aluminum bromide, chloride, iodide, halides similarly of copper, tin, zinc, antimony, arsenic, titanium, etc. hydroxides of sodium, potassium, calcium oxides, sodium carbonate, metallic sodium, nitrogen bases, ozonides and peroxides. Blowing with air can then be continued in the presence of the polymerizing catalyst.

U.S. Pat. No. 2,287,511 discloses an asphalt manufacturing process which involves heating a residuum in the presence of the following catalysts: ferric chloride, aluminum bromide, aluminum chloride, aluminum iodide; halides of copper, tin, zinc, antimony, arsenic, boron, titanium; hydroxides of sodium and potassium; calcium oxides, sodium carbonate, and metallic sodium. These catalysts are described as being present in the asphalt composition in the absence of any injected air. However, air may be injected prior to the addition of the above-cited polymerizing catalysts, but no air is injected when the catalysts have been added to the composition.

U.S. Pat. No. 4,000,000 describes a process for recycling asphalt-aggregate compositions by heating and mixing them with a desired amount of petroleum hydrocarbons containing at least 55% aromatics.

U.S. Pat. No. 2,370,007 reveals a process for oxidizing asphalt which involves air blowing a petroleum oil in the presence of a relatively small amount of certain types of catalysts. These catalysts are organic complexes of metallic salts. Examples of organic complexes of metallic salts that can be used include those obtained from sludges recovered in treating petroleum fractions with metallic salts, such as metallic halides, carbonates and sulfates. The sludge obtained in treating a cracked gasoline with aluminum chloride is disclosed as being particularly suitable in accelerating the oxidation reaction and in producing an asphalt of superior characteristics. The hydrocarbon stocks from which the organic complex of metallic salts may be produced are described as including various hydrocarbon fractions containing hydrocarbons which are reactive with the metallic salts, such as those containing olefinic hydrocarbons. Sludges obtained by treating olefins with aluminum chloride are also described as being useful in the process of this 1943 patent. Other sludges that are identified as being particularly useful can be obtained in the isomerization of hydrocarbons such as butane, pentane and naphtha in the presence of aluminum chloride. These sludges can be obtained by the alkylation of isoparaffins with olefins in the presence of such alkylating catalysts, such as boron trifluoride and the like.

Several patents describe the application of phosphoric mineral acids in modifying asphalt properties. For instance, U.S. Pat. No. 2,450,756 describes a process to make oxidized asphalts by air blowing petroleum hydrocarbon in the presence of a phosphorus catalyst, including phosphorus pentoxide, phosphorus sulfide, and red phosphorus. U.S. Pat. No. 2,762,755 describes a process of air blow asphaltic material in the presence of a small amount of phosphoric acid. U.S. Pat. No. 3,126,329 discloses a method of making blown asphalt through air blowing in the presence of a catalyst which is an anhydrous solution of 50 weight percent to 80 weight percent phosphorus pentoxide in 50 weight percent to 20 weight percent phosphoric acid having the general formula HₘRₙPO₄.

In general the air blowing techniques described in the prior art share the common characteristic of both increasing the softening point and decreasing the penetration value of the asphalt being treated. In other words, as the asphalt is air blown, its softening point increases and its penetration value decreases over the duration of the air blowing procedure. It has been the conventional practice to air blow asphalt for a period of time that is sufficient to attain the desired softening point and penetration value. However, in some cases, air blowing asphalt to the desired softening point using conventional procedures results in a penetration value which is too low to be suitable for utilization in roofing applications. These asphalts are called “hard asphalts”. In other words, hard asphalt cannot be air blown using conventional procedures to a point where both the required softening point and penetration values are attained. Accordingly, there is a need for techniques that can be used to air blow hard asphalt to both a softening point which is within the range of 185° F. (85° C.) to 250° F. (121° C.) and a penetration value at 77° F. (25° C.) of above 15 dmm.

U.S. Pat. Nos. 4,659,389 and 4,544,411 disclose the preparation of satisfactory asphaltic roofing fluxes from otherwise unsatisfactory fluxes which involves the addition of asphaltenes, and saturates in quantities which satisfy certain specified conditions. Air oxidation of the asphalt flux is described in these patents as being surprisingly accelerated by the addition of highly branched saturates, especially in the presence of a carbonate oxidation catalyst. Some examples of saturates which are described in these patents as being useful in the method described therein include slack wax, petrolatums, hydrocarbyl species, and mixtures thereof.

U.S. Pat. No. 7,901,563 discloses a method for preparing an industrial asphalt comprising (1) heating an asphalt flux to a temperature which is within the range of about 400° F. (204° C.) to 550° F. (288° C.) to produce a hot asphalt flux, (2) sparging an oxygen containing gas through the hot asphalt flux for a period of time which is sufficient to increase the softening point of the asphalt flux to a value of at least 100° F. (38° C.), to produce an underblown asphalt composition; and (3) mixing a sufficient amount of a polyphosphoric acid throughout the underblown asphalt composition while the underblown asphalt composition is maintained at a temperature which is within the range of 200° F. (93° C.) to 550° F. (288° C.) to attain a softening point which is within the range of 185° F. (85° C.) to 250° F. (121° C.) and a penetration value of at least 15 dmm at 77° F. (25° C.) to produce the industrial asphalt. The techniques disclosed in this patent is useful in that it can be used to increase the softening point of hard asphalt flux to a commercially desirable level while maintaining the penetration value of the asphalt above 15 dmm at 77° F. (25° C.). Accordingly, this technique can be used to produce industrial asphalt having a desirable softening point and penetration value using hard asphalt flux as the starting material.

Various polymers can be added to asphalt to attain the physical and performance characteristics required in various applications. Asphalt which has been modified with one or more polymers is known as polymer modified asphalt (PMA). A wide variety of polymers have been used in modifying asphalt. These polymers are typically unsaturated such as styrene-butadiene-styrene block copolymers (SBS) and highly saturated (contain a relatively low number of carbon-carbon double bonds). In many cases the highly saturated rubbery polymers used in making conventional polymer modified asphalts will be completely saturated (contain no double bonds). In any case, some examples of polymers that are conventionally used in making polymer modified asphalts include high saturated styrene-ethylene/butylene-styrene block copolymers (SEBS), high saturated styrene-ethylene/propylene-styrene block copolymers (SEPS), styrene-butadiene-styrene block copolymers, polyisobutylene (PIB), butyl rubber, ethylene-propylene rubber, hydrogenated nitrile rubber, and the like. The rubbery polymers that are conventionally used are normally of a relatively high molecular weight and will preferably be primarily linear (contain less than 2% and typically less than 1% carbon atoms which are branch points for polymer chains that contain at least 3 carbon atoms).

U.S. Pat. Nos. 8,901,211 and 9,493,653 disclose a method for preparing an industrial asphalt comprising sparging an oxygen containing gas through an asphalt flux in the presence of 0.25 weight percent to about 12 weight percent of a highly saturated rubbery polymer at a temperature within the range of about 400° F. to about 550° F. for a period of time which is sufficient to increase the softening point of the asphalt flux to a value which is within the range of 185° F. to 250° F. and a penetration value of at least 15 dmm to produce the industrial asphalt. The highly saturated rubbery polymer can be a styrene-ethylene/butylene-styrene block copolymer rubber or a highly saturated styrene-ethylene/propylene-styrene block copolymer rubber.

### SUMMARY OF THE INVENTION

This invention is based upon the discovery that adding liquid polybutadiene having a high-vinyl microstructure content to asphalt and then air blowing the blend (a liquid high-vinyl polybutadiene modified asphalt) produces a flexible and tough blown polymer modified asphalt (PMA). Virtually any type of asphalt can be utilized in the practice of this invention with little regard to compatibility and storage separation concerns that are typically encountered in the conventional production of polymer modified asphalt. This allows for a great deal of flexibility in selecting asphalt as a raw material for modification and permits types of asphalt to be used that would be unusable in conventional modification procedures. The polymer modified asphalt made in accordance with this invention is also superior to conventional polymer modified asphalt in several ways. For instance, it is less ductile as compared to conventional polymer modified asphalt and is also flexible and tough with a relative ability to be stretched while at the same time showing a higher yield strength (resistance to further stretching).

The extent of stretching and elongation can be controlled by appropriate adjustment of the level of the high-vinyl liquid polybutadiene employed in modifying the asphalt and is also a function of the asphalt used as a raw material in the process. The polymer modified asphalt of this invention also typically exhibits improved thermal and storage stability as compared to most conventional polymer modified asphalts. In most cases, the use of the high-vinyl liquid polybutadiene further results in improved oxidative accelerated aging performance.

The method of this invention is also capable of producing flexible and tough blown coating asphalt with high viscosity for applications where high viscosity is needed with little or no filler addition. Its use also results in improved efficiency in the air blowing process with reduced blow loss. This results in reduced capital expenditures in plants and equipment as well as reduced operating costs. For instance, the need for high shear mills which require high capital investment and which are needed in making most conventional polymer modified asphalt is eliminated.

This invention more specifically discloses a liquid high-vinyl polybutadiene modified asphalt which can be air blown in accordance with this invention to make polymer modified asphalt having improved physical and chemical characteristics. This liquid high-vinyl polybutadiene modified asphalt is comprised of an asphalt and a liquid high-vinyl polybutadiene, wherein the liquid high-vinyl polybutadiene is present in the liquid high-vinyl polybutadiene modified asphalt at a level which is within the range of about 0.25 weight percent to about 20 weight percent, based upon the total weight of the liquid high-vinyl polybutadiene modified asphalt. The high-vinyl liquid polybutadiene will typically have a vinyl microstructure content of at least about 85% and will typically have a number average molecular weight of less than about 20,000.

This invention also reveals a method for preparing a flexible and tough polymer modified asphalt composition which comprises sparging an oxygen containing gas through a liquid high-vinyl polybutadiene modified asphalt, wherein the liquid high-vinyl polybutadiene modified asphalt contains from about 0.25 weight percent to about 20 weight percent of the liquid high-vinyl polybutadiene, wherein the oxygen containing gas is sparged through the liquid high-vinyl polybutadiene modified asphalt at a temperature within the range of about 400° F. to about 550° F. for a period of time which is sufficient to increase the softening point of the asphalt to a value which is within the range of 185° F. to 250° F. and to attain a penetration value of at least 15 dmm to produce the polymer modified asphalt composition.

The polymer modified asphalt made in accordance with this invention could be considered for use in manufacturing impact resistant roofing shingles as allowed by the design of the shingle construction and can also be advantageously utilized in making roofing shingles that can be installed in cold weather environments. This invention accordingly further relates to an asphalt roofing shingle which is comprised of a (1) base layer having an upper surface and a bottom surface, (2) an exposure layer which is situated above the upper surface of the base layer, and (3) a bottom layer which is situated under the bottom surface of the base layer, wherein the upper surface of the base layer is coated with a liquid high-vinyl polybutadiene modified asphalt which is comprised of an asphalt and a liquid high-vinyl polybutadiene, wherein the liquid high-vinyl polybutadiene is present in the liquid high-vinyl polybutadiene modified asphalt at a level which is within the range of about 0.25 weight percent to about 20 weight percent, based upon the total weight of the liquid high-vinyl polybutadiene modified asphalt, wherein the liquid high-vinyl polybutadiene modified asphalt has a softening point which is within the range of 185° F. to 250° F. and a penetration value of at least 15 dmm.

This invention accordingly further relates to an asphalt roofing shingle which is comprised of a (1) base layer having an upper surface and a bottom surface, (2) an exposure layer which is situated above the upper surface of the base layer, and (3) a bottom layer which is situated under the bottom surface of the base layer, wherein the upper surface of the base layer is coated with a polymer modified asphalt composition, wherein the polymer modified asphalt composition is made by a process which comprises sparging an oxygen containing gas through a liquid high-vinyl polybutadiene modified asphalt, wherein the liquid high-vinyl polybutadiene modified asphalt contains from about 0.25 weight percent to about 20 weight percent of the liquid high-vinyl polybutadiene, wherein the oxygen containing gas is sparged through the liquid high-vinyl polybutadiene modified asphalt at a temperature within the range of about 400° F. to about 550° F. for a period of time which is sufficient to increase the softening point of the asphalt to a value which is within the range of 185° F. to 250° F. and to attain a penetration value of at least 15 dmm to produce the polymer modified asphalt composition, and wherein the exposure layer is comprised of weather resistant granules which are adhered to the polymer modified asphalt composition.

The polymer modified asphalt made in accordance with this invention also has characteristics which make it particularly useful for coating metal products to improve their corrosion resistance. For instance, vessels for containing aqueous liquids, non-aqueous liquids, and/or gases can be coated with the liquid high-vinyl polybutadiene modified asphalt of this invention to provide enhanced corrosion resistance. More specifically, the outer surface of metal storage tanks, pipes, and tubes can be coated with the polymer modified asphalt of this invention to attain improved corrosion resistance. In one embodiment of this invention, the inner surface of storage tanks, pipes, and tubes can be coated with the liquid high-vinyl polybutadiene modified asphalt of this invention. Pipes and tanks can also be coated with the high vinyl polybutadiene modified asphalt composition of this invention to improve thermal insulation characteristics. Accordingly, the subject invention further reveals a pipe having a tube layer and a lumen, wherein the tube layer is coated with a high vinyl polybutadiene modified asphalt composition, wherein the liquid high-vinyl polybutadiene modified asphalt contains from about 0.25 weight percent to about 20 weight percent of the liquid high-vinyl polybutadiene, wherein the liquid high-vinyl polybutadiene modified asphalt has a softening point which is within the range of 185° F. to 250° F. and a penetration value of at least 15 dmm.

The present invention accordingly also reveals metal storage vessels, such as tanks, having improved corrosion resistance which are coated with a high vinyl polybutadiene modified asphalt composition, wherein the liquid high-vinyl polybutadiene modified asphalt contains from about 0.25 weight percent to about 20 weight percent of the liquid high-vinyl polybutadiene, wherein the liquid high-vinyl polybutadiene modified asphalt has a softening point which is within the range of 185° F. to 250° F. and a penetration value of at least 15 dmm.

The subject invention further discloses a liquid high-vinyl polybutadiene modified asphalt which is comprised of an asphalt and a liquid high-vinyl polybutadiene, wherein the liquid high-vinyl polybutadiene is present in the liquid high-vinyl polybutadiene modified asphalt at a level which is within the range of about 0.25 weight percent to about 20 weight percent, based upon the total weight of the liquid high-vinyl polybutadiene modified asphalt, wherein the liquid high-vinyl polybutadiene modified asphalt has a softening point which is within the range of 185° F. to 250° F. and a penetration value of at least 15 dmm.

In an alternative embodiment of this invention, liquid high-vinyl polybutadiene can be added to partially blown or underblown asphalt to increase the softening point of the asphalt to the desired level. For instance, the liquid high-vinyl polybutadiene can be added to asphalt to attain a desired softening point by adding the amount of liquid high-vinyl polybutadiene needed to attain the desired melting point without adversely affecting other attributes of the polymer modified asphalt composition being prepared. This post addition of the high-vinyl polybutadiene can be done after the asphalt has been partially or fully blown.

### DETAILED DESCRIPTION OF THE INVENTION

Virtually any type of asphalt can be utilized as a raw material in the practice of this invention. The asphalt will normally be the petroleum residue from a vacuum distillation column used in refining crude oil. Such asphalt typically has a softening point which is within the range of 60° F. to 130° F. (16° C. to 54° C.) and more typically has a softening point which is within the range of 80° F. to 110° F. (27° C. to 43° C.). It also typically has a penetration value of at least 150 dmm and more typically has a penetration value of at least 200 dmm at 77° F. (25° C.). The asphaltic material used as the starting material can also be solvent extracted asphalt, naturally occurring asphalt, or synthetic asphalt. Blends of such asphaltic materials can also be treated by the process of this invention. The asphalt can also include polymers, recycled tire rubber, recycled engine oil residue, recycled plastics, softeners, antifungal agents, biocides (algae inhibiting agents), and other additives. Tar and pitch can also be used as the starting material for treatment by the technique of this invention.

The hard asphalt is characterized in that it cannot be air blown to attain both a softening point which is within the range of 185° F. (85° C.) to 250° F. (121° C.) and a penetration value of at least 15 dmm. However, it should be understood that the process of this invention is also applicable to the treatment of virtually any asphaltic materials in addition to hard asphalt. The technique of this invention is of particular value in the treatment of hard asphalt that is impossible to air blow utilizing standard air blowing methods into industrial asphalt having properties suitable for use in roofing applications.

In the first step of the process of this invention the asphalt is heated to a temperature which is within the range of about 120° F. (49° C.) to 550° F. (288° C.) to produce a hot asphalt. In any case, the asphalt will be heated to a temperature which is sufficient to provide for good mixing. In many cases the asphalt will be heated to a temperature which is within the range of about 200° F. (93° C.) to about 500° F. (260° C.). The asphalt will frequently be heated to a temperature which is within the range of about 250° F. (121° C.) to about 400° F. (204° C.) or 450° F. (232° C.) to produce the hot asphalt at which point the high-vinyl liquid polybutadiene is added.

It should be noted that additional asphalt modification polymers can also be added to attain desired asphalt characteristics. For instance, polymers that are conventionally used in making polymer modified asphalts can also be added. Some representative examples of such polymers include styrene-butadiene-styrene block copolymers (SBS), saturated styrene-ethylene/butylene-styrene block copolymers (SEBS), saturated styrene-ethylene/propylene-styrene block copolymers (SEPS), styrene-butadiene-styrene block copolymers, polyisobutylene (PIB), butyl rubber, ethylene-propylene rubber, hydrogenated nitrile rubber, and the like. The rubbery polymers that are conventionally used are normally of a relatively high molecular weight and will preferably be primarily linear (contain less than 2% and typically less than 1% carbon atoms which are branch points for polymer chains that contain at least 3 carbon atoms). In cases where such additional asphalt modification polymers are included they will normally be added in an amount which is within the range of about 0.25 weight percent to about 10 weight percent or can be added at lower levels which are within the range of 0.25 weight percent to about 5 weight percent, based upon the total weight of the liquid high-vinyl polybutadiene modified asphalt.

Then the asphalt is heated to the desired air blowing temperature which is typically within the range of 400° F. (204° C.) to 550° F. (288° C.) and more typically within the range of 450° F. (232° C.) to 525° F. (274° C.). It is often preferred to utilize an air blowing temperature which is within the range of 475° F. (246° C.) to 525° F. (274° C.). In any case the hot asphalt containing the high-vinyl liquid polybutadiene is then air blown to the desired softening point which is typically within the range of 185° F. (85° C.) to 250° F. (121° C.) by blowing an oxygen containing gas through the hot asphalt for the time required to attain the desired softening point while maintaining a penetration value of at least 15 dmm to produce the desired polymer modified asphalt.

The oxygen containing gas (oxidizing gas) is typically air. The air can contain moisture and can optionally be enriched to contain a higher level of oxygen. For example, oxygen enriched air containing from about 25 weight percent to about 35 weight percent oxygen and about 65 weight percent to about 75 weight percent nitrogen can be employed. Chlorine enriched air or pure oxygen can also be utilized in the air blowing step. For instance, chlorine enriched air containing from about 15 weight percent to about 25 weight percent oxygen, about 5 weight percent to about 15 weight percent chlorine, and from about 60 weight percent to about 80 weight percent nitrogen can be utilized as the oxidizing gas.

The duration of the air blow will, of course, be sufficient to attain the desired final softening point and with typically be within the range of about 1 hour to about 30 hours. Air blow can be performed either with or without a conventional air blowing catalyst. However, air blowing catalysts are typically added to the asphalt to reduce the air blow time needed to attain the desired softening point. Some representative examples of air blowing catalysts include ferric chloride (FeCl₃), phosphorous pentoxide (P₂O₅), aluminum chloride (AlCl₃), boric acid (H₃BO₃), copper sulfate (CuSO₄), zinc chloride (ZnCl₂), phosphorous sesquesulfide (P₄S₃), phosphorous pentasulfide (P₂S₅), phytic acid (C₆H₆[OPO—(OH)₂]₆), and organic sulfonic acids. In any case, the duration of the air blow will more typically be within the range of about 1 hour to about 20 hours and is more typically within the range of about 4 hours to about 10 hours or 12 hours. The air blowing step will preferably take about 2 hours to about 8 hours and will more typically take about 3 hours to about 6 hours.

Typically about 0.25 weight percent to about 20 weight percent of high-vinyl liquid polybutadiene will be added to the asphalt. More typically, about 0.5 weight percent to about 15 weight percent of the high-vinyl liquid polybutadiene will be added to the asphalt. Generally, about 1 weight percent to about 12 weight percent of the high-vinyl liquid polybutadiene will be added to the asphalt. More generally, about 2 weight percent to about 10 weight percent of the high-vinyl liquid polybutadiene will be added to the asphalt. It is generally preferred for high-vinyl liquid polybutadiene to be present in the asphalt at a level which is within the range of about 2 weight percent to about 8 weight percent with levels within the range of about 4 weight percent to about 8 weight percent being most preferred. This mixing can normally be accomplished by sparging a gas (either an inert gas or an oxygen containing gas) through the asphalt to thoroughly mix the high-vinyl liquid polybutadiene into it. Accordingly, it is generally not necessary to utilize a Seifer mill or other similar equipment to generate high shear conditions in order to attain adequate mixing of the highly saturated rubbery polymer throughout the asphalt.

The asphalt which is air blown in accordance with this invention will typically be essentially free of sodium carbonate and in most cases will be void of sodium carbonate. The ratio of asphaltenes plus polars to saturates in the asphalt which is air blown in accordance with this invention can be greater than 2.5 and will frequently be greater than 2.8, 2.9, or even 3.0. Thus, the asphalt which is air blown in accordance with this invention will normally satisfy the equation (A+P)/(S)>2.5, wherein “A” represents the weight of asphaltenes in the asphalt, wherein “P” represents the weight of polars in the, and wherein “S” represents the weight of saturates in the asphalt, and wherein the symbol “>” means greater than. In many cases, (A+P)/(S) will be greater than 2.7, 2.9, 3.0, or even 3.2.

The method used to determine the asphaltene, polar, aromatic and saturate content of the roofing asphalts is the clay-gel adsorption chromatographic method of ASTM D-2007. The first step of the clay-gel analysis involves dissolving of the sample to be analyzed into 40 milliliters of pentane for each gram of the sample. The pentane insoluble fraction of the asphalt which is removed by filtration is called the “asphaltenes”. The pentane soluble part of the asphalt, which is called the “maltenes” is eluted through a separable colinear two part column apparatus in which the top column is packed with attapulgus clay and the bottom column is packed with silica gel and attapulgus clay. The two columns are eluted with pentane until 250 ml of pentane eluent has been collected. At this time, the elution of the columns with pentane is stopped, the pentane is evaporated and the residual material obtained is designated as the saturates.

The next step in the clay-gel analysis is to separate the two part column. The attapulgus clay (top) column is eluted with a 50:50 (by volume) mixture of benzene and acetone. The elution is continued until the benzene and acetone mixture emerging from the end of the column is colorless. At this time, the elution is stopped, the benzene-acetone mixture collected is evaporated and the residual material is designated as polars. At this point the asphaltenes, saturates and polars have been determined directly so the aromatics are determined by difference to complete the clay-gel analysis. Other methods which will give results similar to the clay-gel analysis are liquid chromatographic methods, such as the Corbett analysis, ASTM D-4124, and many high performance liquid chromatographic methods.

The high-vinyl liquid polybutadiene used in the practice of this invention is typically a homopolymer of 1,3-butadiene monomer and has a vinyl microstructure content of at least 15%. The liquid high-vinyl polybutadiene will normally have a vinyl microstructure content of at least 60% and will generally have a vinyl microstructure content of at least 65%. In most cases the liquid high-vinyl polybutadiene will have a vinyl microstructure content of at least 70% and will most frequently have a vinyl microstructure content of at least 80%. It is typically preferred for the liquid high-vinyl polybutadiene to have a vinyl microstructure content of at least 85% or even at least 90%. The liquid high-vinyl polybutadiene will typically have a number average molecular weight which is within the range of about 1000 to about 30,000 and will more typically have a number average molecular weight which is within the range of about 1200 to about 20,000. In most cases the liquid high-vinyl polybutadiene will have a number average molecular weight which is within the range of about 1400 to about 15,000. The liquid high-vinyl polybutadiene will more typically have a number average molecular weight which is within the range of about 1600 to about 12,000. The liquid high-vinyl polybutadiene will normally have a number average molecular weight which is within the range of about 2000 to about 10,000 and may have a number average molecular weight which is within the range of about 5000 to about 10,000. In some cases the liquid high-vinyl polybutadiene will have a number average molecular weight which is within the range of about 1600 to about 3,000.

The high-vinyl liquid polybutadiene utilized in the practice of this invention is typically made by the polymerization of 1,3-butadiene monomer by anionic polymerization in an inert organic solvent. For instance, U.S. Pat. No. 6,140,434 discloses a process for preparing high vinyl polybutadiene rubber which comprises: polymerizing 1,3-butadiene monomer with a lithium initiator at a temperature which is within the range of about 5° C. to about 100° C. in the presence of a metal salt of a cyclic alcohol and a polar modifier, wherein the molar ratio of the metal salt of the cyclic alcohol to the polar modifier is within the range of about 0.1:1 to about 10:1; and wherein the molar ratio of the metal salt of the cyclic alcohol to the lithium initiator is within the range of about 0.05:1 to about 10:1. Sodium mentholate is the most highly preferred metal salt of a cyclic alcohol that can be utilized in such a synthesis. However, metal salts of thymol can also be utilized. The metal salt of the cyclic alcohol can be prepared by reacting the cyclic alcohol directly with the metal or another metal source, such as sodium hydride, in an aliphatic or aromatic solvent. As a general rule in all anionic polymerizations, the molecular weight (Mooney viscosity) of the polymer produced is inversely proportional to the amount of initiator utilized. Accordingly, a low level of the initiator will be used to attain the desired low molecular weight liquid polymer. As a general rule, from about 0.01 phm (parts per hundred parts by weight of monomer) to 1 phm of the lithium catalyst will be employed. In most cases, from 0.01 phm to 0.1 phm of the lithium catalyst will be employed with it being preferred to utilize 0.025 phm to 0.07 phm of the lithium catalyst. The teachings of U.S. Pat. No. 6,140,434 are incorporated herein for the purpose of disclosing the a technique of synthesizing high vinyl polybutadiene.

A molecular weight regulator can also be utilized to control the molecular weight of the high-vinyl polybutadiene to produce the desired liquid polymer. For example, U.S. Pat. No. 5,637,661 discloses the use of bis(1,5-cyclooctadiene) nickel for this purpose. The teachings of U.S. Pat. No. 5,637,661 are incorporated herein by reference for the purpose of teaching a method for producing liquid polybutadiene.

A method for synthesizing high vinyl polybutadiene is also disclosed in U.S. Pat. No. 6,566,478. This method involves polymerizing at least one diene monomer with a lithium initiator selected from the group consisting of allylic lithium compounds and benzylic lithium compounds at a temperature which is within the range of about 5° C. to about 120° C. in the presence of a Group I metal alkoxide and a polar modifier, wherein the molar ratio of the Group I metal alkoxide to the polar modifier is within the range of about 0.1:1 to about 10:1; and wherein the molar ratio of the Group I metal alkoxide to the lithium initiator is within the range of about 0.05:1 to about 10:1. It is preferred for the Group I metal alkoxide to be a Group I metal salt of a cyclic alcohol and for the metal salt of the cyclic alcohol to be sodium mentholate.

High-vinyl liquid polybutadiene which is suitable for use in the practice of this invention is also commercially available from Kuraray as LBR-352 having a molecular weight of 9,000 and LBR-361 having a molecular weight of 5,500. Suitable high-vinyl liquid polybutadiene is also available from Cray Valley of Exton, Pa., as Ricon® 151 having a molecular weight of 2,000 and a 1,2-vinyl microstructure content of 70%, Ricon® 152 having a molecular weight of 1,800 and a 1,2-vinyl microstructure content of 80%, Ricon® 153 having a molecular weight of 2,800 and a 1,2-vinyl microstructure content of 80%, and Ricon® 154 having a molecular weight of 2,800 and a 1,2-vinyl microstructure content of 90%.

The industrial asphalt made can be used in making roofing products and other industrial products using standard procedures. For instance, the industrial asphalt can be blended with fillers, stabilizers (like limestone, stonedust, sand, granule, etc.), polymers, recycled tire rubber, recycled engine oil residue, recycled plastics, softeners, antifungal agents, biocides (algae inhibiting agents), and other additives.

The polymer modified asphalt made in accordance with this invention can have a softening point which is within the range of 185° F. (85° C.) to 250° F. (121° C.) and a penetration value of at least 15 dmm. In most cases, the polymer modified asphalt will have a penetration value which is within the range of 15 dmm to 35 dmm. Polymer modified asphalt that is made by the process of this invention for utilization in roofing applications will typically have a softening point which is within the range of 185° F. (85° C.) to 250° F. (121° C.) and a penetration value which is within the range of 15 dmm to 35 dmm. Polymer modified asphalt made by the process of this invention for roofing applications will preferably have a softening point which is within the range of 185° F. (85° C.) to 220° F. (104° C.) and a penetration value which is within the range of 15 dmm to 25 dmm. Polymer modified asphalt made by the process of this invention for roofing applications will more preferably have a softening point which is within the range of 190° F. (88° C.) to 210° F. (99° C.) and a penetration value which is within the range of 15 dmm to 25 dmm. In some cases the polymer modified asphalt will have a softening point which is within the range of 190° F. (88° C.) to 215° F. (102° C.) and a penetration value which is within the range of 15 dmm to 20 dmm.

This invention is illustrated by the following examples that are merely for the purpose of illustration and are not to be regarded as limiting the scope of the invention or the manner in which it can be practiced. Unless specifically indicated otherwise, parts and percentages are given by weight.

### Examples

In this series of experiments liquid high vinyl polybutadiene modified asphalt was made in accordance with the method of this invention. In the procedure used an asphalt sample was heated in a laboratory oven set at 400° F. (204° C.). Once the asphalt was heated, the desired amount was poured into the top of a laboratory blow still. When the asphalt was added to the blow still its temperature was within the range of 200° F. to 250° F. (93° C. to 121° C.). The blow still used had a total capacity of approximately 0.57 gallons (2.16 liters) and was filled to about 60% of its capacity with the asphalt samples being modified. More specifically, the 1 gallon blow still was filled with about 2000 grams of unmodified asphalt.

The desired amount of high-vinyl liquid polybutadiene was then added to the top of the hot asphalt in the blow still. The blow still lid was then securely fastened and the blow still was connected to power and an air source. The external band heaters on the blow stills were also turned on. An air flow rate of 1 liter per minute was established when the blow stills reached a temperature of 300° F. (149° C.). This air flow created agitation which was sufficient to mix the high-vinyl liquid polybutadiene into the asphalt and allowed for even heating of the blend in the blow still. The air pressure into the system was regulated to 20 pounds per square inch (0.138 megapascals).

Full air flow was established when the blow still temperatures reached within 2% of the 475° F. (246° C.) target air blow temperature. This point was considered to be the start of the oxidation. The full air flow rate for the blow still was set at 20 liters per minute. During the air blow samples of the asphalt compositions were periodically taken to determine softening points. After the target softening points were achieved the air blowing (oxidation) was completed and the blend was drained from the blow still. Final softening points, penetration values, and viscosities were then determined for each of the asphalt samples. For purposes of this invention, asphalt softening points were measured following ASTM D3461 (Standard Test Method for Softening Point of Asphalt and Pitch (Mettler Cup-and-Ball Method)), asphalt penetrations were measured following ASTM D5 (Standard Test Method for Penetration of Bituminous Materials), viscosities were determined according to ASTM D4402 (Standard Test Method for Viscosity Determination of Asphalt at Elevated Temperatures Using a Rotational Viscometer), flash points were determined according to ASTM D92 (Standard Test Method for Flash and Fire Points by Cleveland Open Cup Tester), stain index was determined according to ASTM D2746 (Standard Test Method for Staining Tendency of Asphalt), and blow loss was calculated on the basis of the mass balance of the system.

The following table provides a number of examples which illustrate polymer modified asphalt made in accordance with this invention.

| | | | | | Penetration at | | | | | |
|---|---|---|---|---|---|---|---|---|---|---|
| | | | | | 77° F. (dmm) | | | Tensile test at 2 inch/minute rate | | |
| | | | | | Normalized to | | | at 60° F. | | |
| | | Polybutadiene | Softening | Viscosity | 208° F. | Blow | | | Elongation | Tensile |
| Asphalt | | (PB) Added | Point | at 400° F. | Softening | Time | Blow | Peak | at Peak | Extension |
| Stream | Examples | (%) | (° F.) | (cP) | point | (minutes) | Loss (%) | load (lbf) | Load (%) | (inches) |
| A | A1 | 0.00% | 208 | 170 | 19 | 227 | 2.00 | 14.1 | 14 | 1.2 |
| | A2 | 4.00% | 204 | 475 | 21.8 | 110 | 1.03 | 7.2 | 25 | 2.4 |
| | A3 | 5.00% | 231 | 1295 | 24.9 | 102 | 1.08 | 9.2 | 27 | 2.7 |
| B | B1 | 0.00% | 204 | 207 | 19 | 298 | 2.11 | 12.2 | 13 | 1.3 |
| | B2 | 3.00% | 208 | 307 | 22 | 202 | 0.87 | 8.8 | 17 | 1.7 |
| | B3 | 5.00% | 229 | 1196 | 21.2 | 138 | 1.02 | 11.3 | 23 | 2.7 |
| C | C1 | 0.00% | 208 | 391 | 8 | 220 | 3.35 | 28.2 | 4 | 0.1 |
| | C2 | 0.00% | 178 | 144 | 7 | 139 | 0.73 | 17.5 | 13 | 1.2 |
| | C3 = C2 + | 8.50% | 211 | 193 | 18.6 | 139 | 0.73 | 16.8 | 8 | 2.9 |
| | 8% PB | | | | | | | | | |
| G | G1 | 0.00% | 213 | 255 | 9.3 | 226 | 6.5 | | | |
| | G2 | 0.00% | 184 | 143 | 9.0 | 115 | 4.0 | | | |
| | G3 = G2 + | 8.50% | 222 | 193 | 18.0 | 115 | 4.0 | | | |
| | 8.5% PB | | | | | | | | | |
| H | H1 | 0.00% | 211 | 243 | 15.9 | 106 | 2.62 | | | |
| | H2 + 2% PIB | 2.00% | 208 | 260 | 17.3 | 131 | 0.85 | | | |
| D | □D1 | SBS Conc. | 211 | 352 | 28.3 | N/A | N/A | 6.4 | 23 | >10 |
| (commercially | | unknown | | | | | | | | |
| available PMA | | | | | | | | | | |
| coating for | | | | | | | | | | |
| shingles | | | | | | | | | | |
| production) | | | | | | | | | | |
| E | □E1 | SBS Conc. | 224 | 319 | 29.6 | N/A | N/A | 8.6 | 23 | >10 |
| (Commercially | | unknown | | | | | | | | |
| available PMA | | | | | | | | | | |
| coating for | | | | | | | | | | |
| shingles | | | | | | | | | | |
| production) | | | | | | | | | | |

Examples A & B show that the technology of this invention can be used to further tune properties of suitable blown asphalt coating for roofing shingles and other applications. Examples C & G demonstrate that this technology is capable of converting asphalt streams which cannot be blown to useful coating for shingles and other roofing materials into suitable blown coating for such applications. Example H shows that polybutadiene polymer and the likes can be combined with other polymers, in this case polyisobutylene(PIB) to influence asphalt properties and to convert asphalt streams which would typically not make good blown coatings into suitable blown coatings for shingles and other applications.

While certain representative embodiments and details have been shown for the purpose of illustrating the subject invention, it will be apparent to those skilled in this art that various changes and modifications can be made therein without departing from the scope of the subject invention.

What is claimed is:

1. A liquid high-vinyl polybutadiene modified asphalt which is comprised of an asphalt and a liquid high-vinyl polybutadiene, wherein the liquid high-vinyl polybutadiene is present in the liquid high-vinyl polybutadiene modified asphalt at a level which is within the range of about 0.25 weight percent to about 20 weight percent, based upon the total weight of the liquid high-vinyl polybutadiene modified asphalt.

2. The liquid high-vinyl polybutadiene modified asphalt as specified in claim 1 wherein the liquid high-vinyl polybutadiene has a number average molecular weight which is within the range of about 1000 to about 30,000.

3. The liquid high-vinyl polybutadiene modified asphalt as specified in claim 1 wherein the liquid high-vinyl polybutadiene has a number average molecular weight which is within the range of about 1600 to about 3,000.

4. The liquid high-vinyl polybutadiene modified asphalt as specified in claim 1 wherein the liquid high-vinyl polybutadiene has a vinyl microstructure content of at least 15%.

5. The liquid high-vinyl polybutadiene modified asphalt as specified in claim 1 wherein the liquid high-vinyl polybutadiene has a vinyl microstructure content of at least 60%.

6. The liquid high-vinyl polybutadiene modified asphalt as specified in claim 1 wherein the liquid high-vinyl polybutadiene has a vinyl microstructure content of at least 90%.

7. The liquid high-vinyl polybutadiene modified asphalt as specified in claim 1 wherein the liquid high-vinyl polybutadiene is present in the liquid high-vinyl polybutadiene modified asphalt at a level which is within the range of about 0.5 weight percent to about 15 weight percent, based upon the total weight of the liquid high-vinyl polybutadiene modified asphalt.

8. The liquid high-vinyl polybutadiene modified asphalt as specified in claim 1 wherein the liquid high-vinyl polybutadiene is present in the liquid high-vinyl polybutadiene modified asphalt at a level which is within the range of about 4 weight percent to about 8 weight percent, based upon the total weight of the liquid high-vinyl polybutadiene modified asphalt.

9. A method for preparing a flexible and tough polymer modified asphalt composition which comprises sparging an oxygen containing gas through a liquid high-vinyl polybutadiene modified asphalt, wherein the liquid high-vinyl polybutadiene modified asphalt contains from about 0.25 weight percent to about 20 weight percent of the liquid high-vinyl polybutadiene, wherein the oxygen containing gas is sparged through the liquid high-vinyl polybutadiene modified asphalt at a temperature within the range of about 400° F. to about 550° F. for a period of time which is sufficient to increase the softening point of the asphalt to a value which is within the range of 185° F. to 250° F. and to attain a penetration value of at least 15 dmm to produce the flexible and tough polymer modified asphalt composition.

10. The method as specified in claim 10 wherein the polymer modified asphalt composition has a softening point which is within the range of 190° F. to 220° F., and wherein the polymer modified asphalt composition has a penetration value which is within the range of 15 dmm to 25 dmm.

11. The method as specified in claim 10 wherein the oxygen containing gas is sparged through the asphalt for a period of time which is within the range of 1 hour to 8 hours, wherein asphalt is further comprised of an air blowing catalyst.

12. The method as specified in claim 9 wherein the asphalt would not be suitable for conversion into industrial asphalt by conventional techniques and/or wherein the time need to air blow the asphalt to attain industrial asphalt having required softness and penetration values as well as blow loss is reduced

13. An asphalt roofing shingle which is comprised of a (1) base layer having an upper surface and a bottom surface, (2) an exposure layer which is situated above the upper surface of the base layer, and (3) a bottom layer which is situated under the bottom surface of the base layer, wherein the upper surface of the base layer is coated with the liquid high-vinyl polybutadiene modified asphalt specified in claim 1, wherein the liquid high-vinyl polybutadiene modified asphalt has a softening point which is within the range of 185° F. to 250° F. and a penetration value of at least 15 dmm.

14. The asphalt roofing shingle as specified in claim 13 wherein the weather resistant granules are selected from the group consisting of slate granules, schist granules, quartz granules, vitrified brick granules, stone granules, and ceramic granules.

15. The asphalt roofing shingle as specified in claim 13 wherein bottom layer is comprised of material which is resistant to sticking and wherein the material which is resistant to sticking is selected from the group consisting of sand, talc and mica.

16. The asphalt roofing shingle as specified in claim 13 wherein the asphalt roofing shingle is adapted for installation in cold weather environments.

17. An asphalt roofing shingle which is comprised of a (1) base layer having an upper surface and an bottom surface, (2) an exposure layer which is situated above the upper surface of the base layer, and (3) a bottom layer which is situated under the bottom surface of the base layer, wherein the upper surface of the base layer is coated with the liquid high-vinyl polybutadiene modified asphalt composition of claim 1, wherein the liquid high-vinyl polybutadiene modified asphalt has a softening point which is within the range of 185° F. to 250° F. and a penetration value of at least 15 dmm, and wherein the exposure layer is comprised of weather resistant granules which are adhered to the polymer modified asphalt composition.

18. A metal pipe having a tube layer and a lumen, wherein the tube layer is coated with the polymer modified asphalt composition of claim 1, and wherein the liquid high-vinyl polybutadiene modified asphalt has a softening point which is within the range of 185° F. to 250° F. and a penetration value of at least 15 dmm.

19. The pipe of claim 18 wherein both the outer surface and the inner surface of the tube layer is coated with the liquid high-vinyl polybutadiene modified asphalt.

20. A metal storage tank having an inner surface and an outer surface, wherein the inner surface of the storage tank is coated with the polymer modified asphalt composition of claim 1, and wherein the liquid high-vinyl polybutadiene modified asphalt has a softening point which is within the range of 185° F. to 250° F. and a penetration value of at least 15 dmm.

21. A method for preparing a polymer modified asphalt composition which comprises dispersing a liquid high-vinyl polybutadiene throughout a partially blown or fully blown asphalt, wherein the liquid high-vinyl polybutadiene is added at a level which is within the range of 0.25 weight percent to 20 weight percent, based upon the total weight of the polymer modified asphalt composition.

22. The liquid high-vinyl polybutadiene modified asphalt of claim 21 which is further comprised of polyisobutylene.
